(19) United States
(12) Patent Application Publication
(10) Pub. No.: US 2019/0016293 A1
(43) Pub. Date: Jan. 17, 2019

(54) AIR BAG APPARATUS

(71) Applicant: HONDA MOTOR CO., LTD., Tokyo (JP)

(72) Inventor: Takashi Saso, Wako-shi (JP)

(21) Appl. No.: 16/015,221

(22) Filed: Jun. 22, 2018

(30) Foreign Application Priority Data
Jul. 11, 2017 (JP) 2017-135548

(51) Int. Cl. B60R 21/233; B60R 21/264; B60R 21/207; B60R 21/2338; B60R 21/231

(52) U.S. Cl. CPC B60R 21/233; B60R 21/264; B60R 2021/0032; B60R 21/2338; B60R 21/23138; B60R 21/207

(57) ABSTRACT

An air bag apparatus includes: an inflator that generates a gas when an impact is input; and a bag body that is supplied with the gas from the inflator and that is inflated and expanded from a seatback of a vehicle seat. The bag body includes: a trunk support part that is expanded to an opposite side of the seatback so as to support a trunk of an occupant who is seated on the vehicle seat; and a pair of head support parts each of which is expanded to each of both sides in a width direction of the vehicle seat so as to support a head part of the occupant and that is connected to the trunk support part. An escape part that penetrates in a vertical direction between the pair of head support parts and that avoids the head part of the occupant in an expansion state is formed on the bag body.

### CROSS-REFERENCE TO RELATED APPLICATION

Priority is claimed on Japanese Patent Application No. 2017-135548, filed on Jul. 11, 2017, the contents of which are incorporated herein by reference.

### BACKGROUND

### Field of the Invention

The present invention relates to an air bag apparatus.

### BACKGROUND

In the related art, air bag apparatuses are known which are embedded in a vehicle seat and which expand a bag body so as to cover an upper body of an occupant when an impact is input to a vehicle and restrain the occupant.

For example, Japanese Patent Application, Publication No. 2010-126141 discloses a vehicle occupant restraint apparatus that includes restraint means which restrains a head part and a trunk upper part of an occupant, wherein the restraint means includes an air bag (bag body) and a net or the like that is connected to the air bag, a front end part of the air bag expands to the front of the head part of the occupant at the time of vehicle collision, a front end part of the net or the like expands more frontward than the front end part of the air bag, and the restraint means is expanded so as to surround the head part and the trunk upper part of the occupant.

### SUMMARY

In the related art described above, the bag body expands so as to cover the head part of the occupant from an upper direction. It is necessary to allow the bag body that covers the head part of the occupant to accurately expand to pass through a space between the head part of the occupant and a ceiling. However, since the position of the head part of the occupant is different depending on the physical size of the occupant, it is necessary to stabilize the behavior at the time of expansion of the bag body in order to allow the bag body to pass through the space between the head part of the occupant and the ceiling, and there may be cases in which the expansion speed of the bag body is limited. Accordingly, in the air bag apparatus that restrains the upper body of the occupant, there is room for improvement in that the expansion speed of the bag body needs to be enhanced, and the bag body needs to be smoothly expanded.

An aspect of the present invention provides an air bag apparatus capable of smoothly expanding a bag body and capable of restraining an upper body of an occupant.

An air bag apparatus according to an aspect of the present invention includes: an inflator that generates a gas when an impact is input; and a bag body that is supplied with the gas from the inflator and that is inflated and expanded from a seatback of a vehicle seat, wherein the bag body includes: a trunk support part that is expanded to an opposite side of the seatback so as to support a trunk of an occupant who is seated on the vehicle seat; and a pair of head support parts each of which is expanded to each of both sides in a width direction of the vehicle seat so as to support a head part of the occupant and that is connected to the trunk support part, and an escape part that penetrates in a vertical direction between the pair of head support parts and that avoids the head part of the occupant in an expansion state is formed on the bag body.

According to the present configuration, since the bag body includes the trunk support part that is expanded to the opposite side of the seatback so as to support the trunk of the occupant who is seated on the vehicle seat, it is possible to restrain the upper body of the occupant. Further, since the escape part that penetrates in the vertical direction between the pair of head support parts in an expansion state and that avoids the head part of the occupant is formed on the bag body, it is possible to expand the bag body while avoiding the head part of the occupant. Thereby, it is possible to enhance the expansion speed of the bag body compared to the related art in which the bag body is formed so as to cover the head part of the occupant. Accordingly, it is possible to smoothly expand the bag body, and it is possible to restrain the upper body of the occupant.

In the air bag apparatus described above, an upper end edge of the head support part may be formed so as to protrude upward when seen from the width direction.

According to the present configuration, it is possible to protect the head part of the occupant and/or support the head part of the occupant at a time of lateral collision by the head support part.

In the air bag apparatus described above, a width of the head support part may be narrower toward an upward direction when seen from the width direction.

According to the present configuration, in a case where the head support part is formed so as to overlap with the head part of the occupant when seen from the width direction of the vehicle seat, it is possible to reduce the volume of the head support part compared to a configuration in which the head support part extends at a constant width toward the upward direction when seen from the width direction. Thereby, since the time required for inflating and expanding the head support part is shortened, it is possible to smoothly expand the bag body.

In the air bag apparatus described above, the bag body may include a side bag that is expanded to at least one side of the width direction with respect to a trunk of the occupant, and the side bag may be expanded prior to the trunk support part.

In general, the distance to an occupant from the side part of a vehicle is shorter than the distance to the occupant from the front end part of the vehicle. Therefore, when comparing front collision and side collision among vehicle collision, it is desirable to perform protection of the occupant against an object that collides with the vehicle at the time of the side collision more promptly than at the time of the front collision. According to the present configuration, since the side bag is expanded prior to the trunk support part, it is possible to improve an occupant protection performance at the time of the side collision of the vehicle compared to a configuration in which the trunk support part is expanded prior to the side bag or a configuration in which the trunk support part is expanded simultaneously with the side bag.

The air bag apparatus described above may include a connection member that connects together the trunk support part that is inflated and expanded and any one of the vehicle seat and the vehicle body.

According to the present configuration, it is possible to regulate the movement of the expanded trunk support part by the connection member. Thereby, it is possible to receive frontward movement of the upper body of the occupant further reliably by the trunk support part. Accordingly, it is possible to stably restrain the upper body of the occupant.

According to an aspect of the present invention, it is possible to provide an air bag apparatus capable of smoothly expanding the bag body and capable of restraining the upper body of the occupant.

### BRIEF DESCRIPTION OF THE DRAWINGS

FIG. 1 is a perspective view of a vehicle seat that includes an air bag apparatus of an embodiment.

FIG. 2 is a view showing a state in which the air bag apparatus of the embodiment is expanded.

FIG. 3 is a view showing an operation of the air bag apparatus of the embodiment.

FIG. 4 is a view showing an operation of the air bag apparatus of the embodiment.

FIG. 5 is a view showing an operation of the air bag apparatus of the embodiment.

### DESCRIPTION OF THE EMBODIMENTS

Hereinafter, an embodiment of the present invention will be described with reference to the drawings. In the following description, the same reference numeral is given to configurations having the same or similar function. There may be cases in which redundant description of the configurations is omitted.

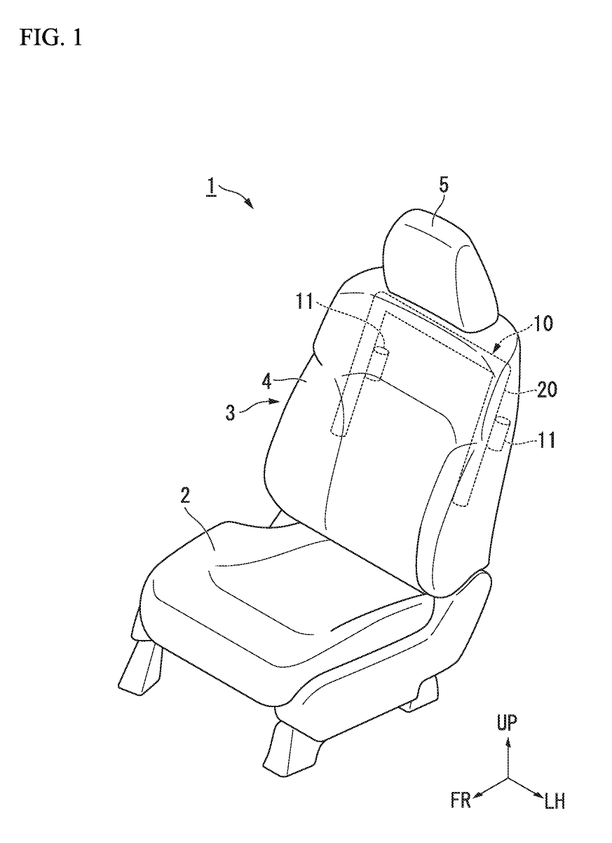

FIG. 1 is a perspective view of a vehicle seat that includes an air bag apparatus of an embodiment.

As shown in FIG. 1, a vehicle seat 1 that includes an air bag apparatus 10 of the embodiment is, for example, a driver seat, a passenger seat, a rear seat, or the like. The vehicle seat 1 includes a seat cushion 2 that supports the hip of an occupant and a seatback 3 that is connected to a rear end part of the seat cushion 2 and that supports the upper body (a trunk, a neck part, and a head part) of the occupant. Front-to-rear, vertical, and right-to-left directions in the following description are the same as front-to-rear, vertical, and right-to-left directions in the vehicle seat 1 if there is no particular description. In the drawings, an arrow UP indicates an upward direction, an arrow FR indicates a frontward direction, and an arrow LH indicates a leftward direction. The right-to-left direction of the vehicle seat 1 corresponds to the width direction of the vehicle seat 1.

The seat cushion 2 includes: a frame (not shown) that forms a skeleton of the seat cushion 2; a pad material (not shown) that is formed of, for example, a urethane foam and the like and that is attached to the frame; and a cover (not shown) that is formed of, for example, a synthetic fiber, leather, and the like and that covers the frame and the pad material. The seatback 3 is connected to a rear end part of the seat cushion 2 in a tiltable manner. The seatback 3 includes a seatback main body 4 that supports, for example, the waist part and the back part of the occupant and a headrest 5 that is attached to an upper end part of the seatback main body and that supports, for example, the head part of the occupant. The seatback 3 is formed of a frame, a pad material, and a cover similarly to the seat cushion 2. The seatback main body 4 and the headrest 5 may be integrally formed.

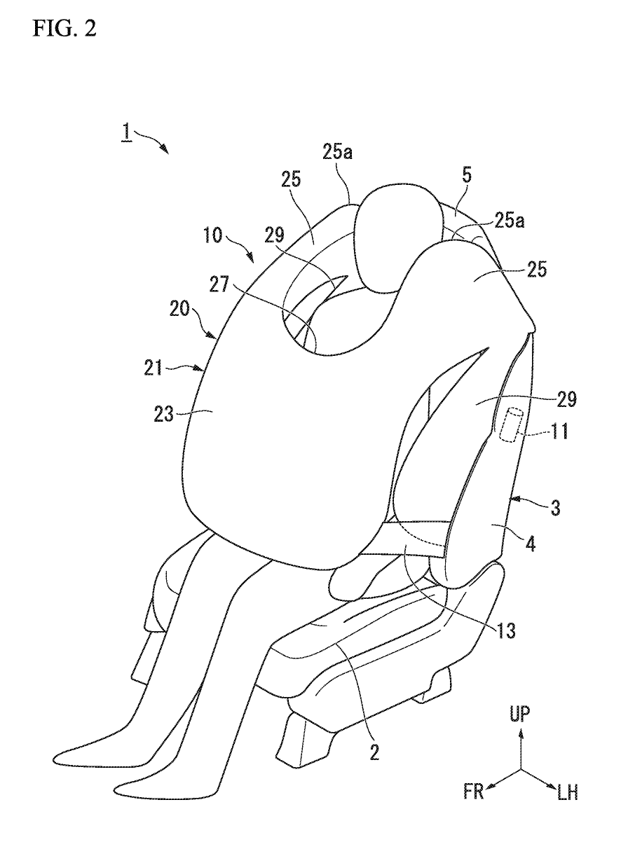

The air bag apparatus 10 is embedded in the seatback 3. In the present embodiment, the air bag apparatus 10 is embedded in the seatback main body 4. The air bag apparatus 10 restrains the upper body of the occupant when being operated. The air bag apparatus 10 includes an inflator 11, a bag body 20, and a pair of connection members 13 (refer to FIG. 2; however, only one connection member 13 is shown).

The inflator 11 generates a high-pressure gas when an impact is input to a vehicle. The inflator 11 is attached to a frame that forms the seatback 3. Each of a pair of inflators 11 is provided corresponding to each of a pair of side bags 29 (refer to FIG. 2) described later.

FIG. 2 is a view showing a state in which the air bag apparatus of the embodiment is expanded and is a perspective view of the vehicle seat that includes the air bag apparatus of the embodiment.

As shown in FIG. 2, the bag body 20 is accommodated inside the seatback 3, for example, in a state of being folded or in a state of being wound and is supplied with the gas from the inflator 11 to be inflated and expanded from the seatback 3. The bag body 20 is attached to the frame that forms the seatback 3. The bag body 20 includes a main bag 21 and a pair of side bags 29. The bag body 20 is formed of a single foundation cloth or a plurality of foundation cloths that are seamed to each other in a bag form in which the main bag 21 and the pair of side bags 29 are integrated. That is, the inside of the main bag 21 and the inside of the side bag 29 form a continuing space. In the following description regarding the bag body 20, a state (a state shown in FIG. 2) in which the expansion of the bag body 20 is completed is described unless specifically stated.

The main bag 21 is arranged throughout a range from the upper part of the seatback main body 4 to the front part of the trunk of the occupant. The main bag 21 breaks the seam and the like of the cover and is expanded from an upper end of the seatback main body 4. The main bag 21 includes a trunk support part 23 that is expanded to an opposite side (that is, a frontward direction of the occupant) of the seatback 3 so as to support the trunk of the occupant and a pair of head support parts 25 each of which is expanded to each of both right and left sides so as to support the head part of the occupant.

The trunk support part 23 is formed so as to overlap with the entire trunk of the occupant when seen from the frontward direction. The trunk support part 23 is formed in, for example, a rectangular shape when seen from the frontward direction. The trunk support part 23 is formed along the front surface of the trunk of the occupant.

Each of the pair of head support parts 25 extends frontward from an upper end of the seatback main body 4 when seen from the vertical direction, passes above a shoulder part of the occupant, and is connected to an upper end of the trunk support part 23. Each head support part 25 is formed integrally with the trunk support part 23. The inside of each head support part 25 is in communication with the inside of the trunk support part 23. An upper end edge 25a of each head support part 25 is formed so as to protrude upward when seen from the right-to-left direction. Further, the width of each head support part 25 is narrower toward an upward direction when seen from a right-to-left direction. Thereby, each head support part 25 is formed so as to overlap with the head part and the neck part of the occupant when seen from the right-to-left direction. Rear end parts of the pair of head support parts 25 may be connected to each other at an outer side of the seatback 3. Thereby, it is possible to protect the head part of the occupant and/or support the head part of the occupant at the time of lateral collision by each head support part 25.

An escape part 27 that penetrates in the vertical direction between the pair of head support parts 25 and that avoids the head part of the occupant in a state where expansion is completed is formed on the main bag 21. That is, the escape part 27 is a penetration part that penetrates in the vertical direction at a position that corresponds to the neck part and the head part of the occupant. The escape part 27 is formed of an upper end edge of the trunk support part 23 and a side edge that faces the head part of the occupant when seen from the vertical direction in each head support part 25 in a cutout shape that opens rearward. As described above, when the rear end parts of the pair of head support parts 25 are connected to each other, the escape part 27 is formed as a penetration hole that penetrates in the vertical direction. When the trunk of the occupant is moved in a vehicle frontward direction, or when the head part of the occupant falls toward the vehicle frontward direction, an end part of the escape part 27 can receive the head part of the occupant.

The pair of side bags 29 is expanded to both sides in the right-to-left direction so as to support the trunk of the occupant. The side bag 29 breaks the seam and the like of the cover and is expanded frontward from both right and left end parts of the seatback main body 4. The side bag 29 is formed so as to overlap with the trunk of the occupant when seen from the right-to-left direction. An upper part of the side bag 29 is connected to the head support part 25 of the main bag 21. The inside of the side bag 29 is in communication with the inside of the main bag 21 at an upper end part of the side bag 29. The inflator 11 is connected to each of the side bags 29. Thereby, the gas from the inflator 11 flows first to the side bag 29.

Each of the pair of connection members 13 (only a left connection member 13 is shown) connects together the seatback 3 and the main bag 21 at each of both sides in the right-to-left direction that support the trunk of the occupant. Each connection member 13 is a webbing that is formed in a band shape, for example, by inweaving a polyester fiber. Each connection member 13 is connected to an end part in the right-to-left direction at a lower portion of the trunk support part 23 of the main bag 21. Each connection member 13 is connected to the frame that forms the seatback 3 in an inner part of the seatback 3. Each connection member 13 is accommodated inside the seatback 3, for example, in a state of being folded or in a state of being wound together with the bag body 20 in an unexpanded state of the bag body 20. Each connection member 13 may be connected to a pretensioner (not shown) at an end part on the seatback 3 side and may have a configuration such that the slack is rolled up when the expansion of the main bag 21 is completed.

Hereinafter, an operation of the air bag apparatus 10 is described.

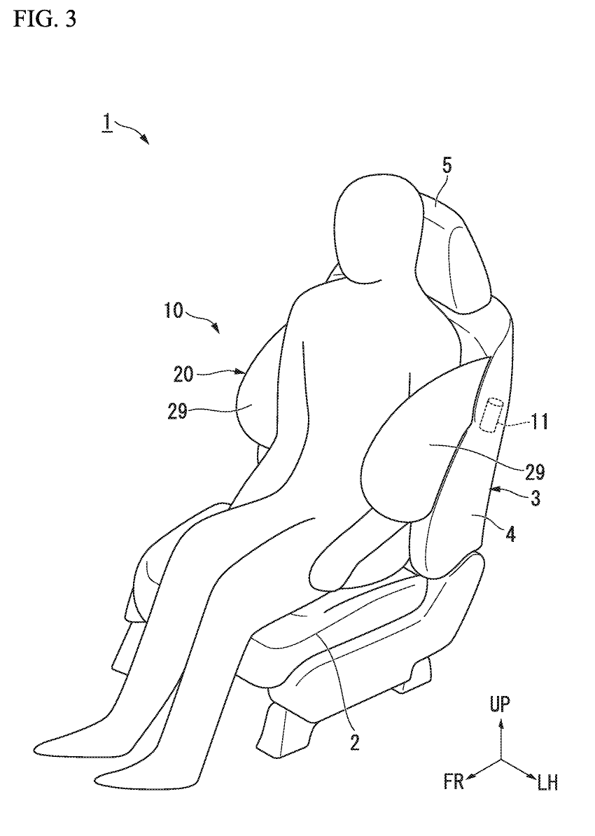

FIG. 3 to FIG. 5 are views showing an operation of the air bag apparatus of the embodiment and perspective views of the vehicle seat that includes the air bag apparatus of the embodiment.

When an impact is input to a vehicle, each inflator 11 generates a high-pressure gas. When the gas is generated from the inflator 11, as shown in FIG. 3, the pair of side bags 29 is supplied with the gas and is first inflated and expanded. That is, the air bag apparatus 10 expands the side bag 29 prior to the trunk support part 23.

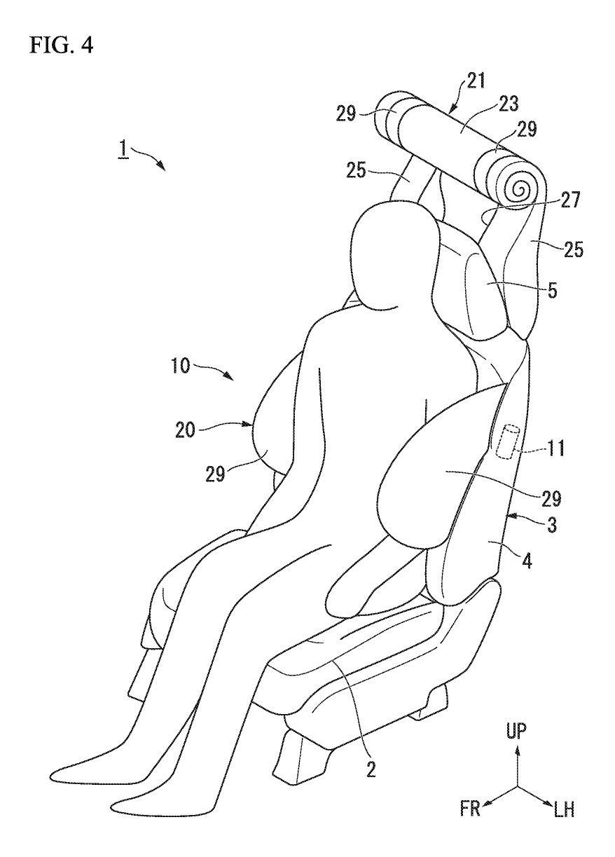

Subsequently, when the expansion of the side bag 29 is completed, the gas is supplied to the main bag 21 from the upper end part of the side bag 29, and the inflation and expansion of the main bag 21 is started. The upper end of the side bag 29 is connected to the head support part 25 of the main bag 21 (refer to FIG. 2). Therefore, as shown in FIG. 4, the main bag 21 is inflated and expanded from the pair of head support parts 25 first. Thereby, before the expansion of the trunk support part 23 is completed, the escape part 27 is formed on the main bag 21.

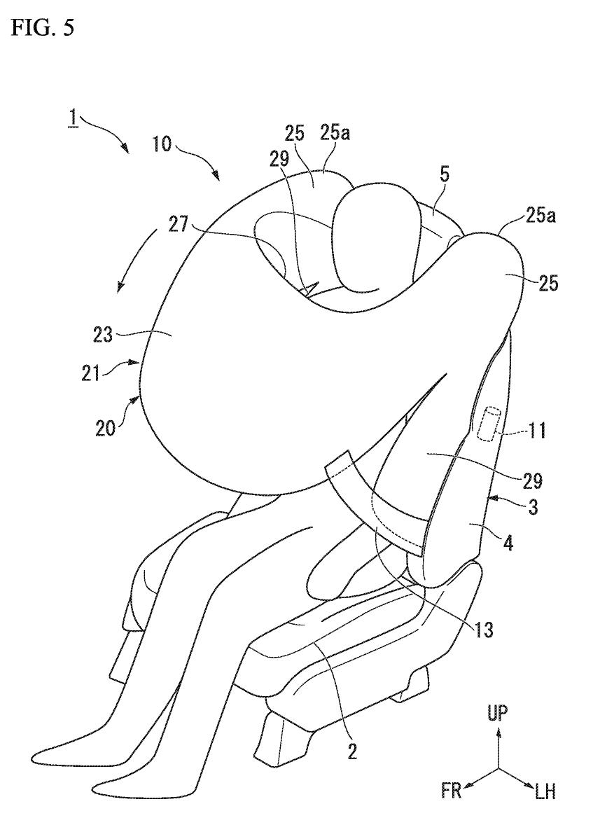

Subsequently, when the expansion of the pair of head support parts 25 is partly completed, the gas is supplied to the trunk support part 23. Thereby, as shown in FIG. 5, the main bag 21 is inflated and expanded such that the head of the occupant enters the inside of the escape part 27. Then, the trunk support part 23 is expanded in front of the trunk of the occupant.

Finally, the operation of the air bag apparatus 10 is completed.

In this way, according to the present embodiment, since the bag body 20 includes the trunk support part 23 that is expanded to the opposite side of the seatback 3 so as to support the trunk of the occupant who is seated on the vehicle seat 1, it is possible to restrain the upper body of the occupant. Further, since the escape part 27 that penetrates in the vertical direction between the pair of head support parts 25 in an expansion state and that avoids the head part of the occupant is formed on the bag body 20, it is possible to expand the bag body 20 while avoiding the head part of the occupant. Thereby, it is possible to enhance the expansion speed of the bag body 20 compared to the related art in which the bag body is formed so as to cover the head part of the occupant. Accordingly, it is possible to smoothly expand the bag body 20, and it is possible to restrain the upper body of the occupant.

Further, since the width of the head support part 25 is narrower toward the upward direction when seen from the right-to-left direction, in a case where the head support part is formed so as to overlap with the head part of the occupant when seen from the right-to-left direction, it is possible to reduce the volume of the head support part 25 compared to a configuration in which the head support part extends at a constant width toward the upward direction when seen from the width direction. Thereby, since the time required for inflating and expanding the head support part 25 is shortened, it is possible to smoothly expand the bag body 20.

Further, in general, the distance to an occupant from the side part of a vehicle is shorter than the distance to the occupant from the front end part of the vehicle. Therefore, when comparing front collision and side collision among vehicle collision, it is desirable to perform protection of the occupant against an object that collides with the vehicle at the time of the side collision more promptly than at the time of the front collision. According to the present embodiment, since the side bag 29 is expanded prior to the trunk support part 23, it is possible to improve an occupant protection performance at the time of the side collision of the vehicle compared to a configuration in which the trunk support part is expanded prior to the side bag or a configuration in which the trunk support part is expanded simultaneously with the side bag.

Further, since the air bag apparatus 10 includes the connection member 13 that connects together the seatback 3 and the trunk support part 23 that is inflated and expanded, it is possible to regulate the movement of the expanded trunk support part 23 by the connection member 13. Thereby, it is possible to receive frontward movement of the upper body of the occupant further reliably by the trunk support part 23. Accordingly, it is possible to stably restrain the upper body of the occupant.

The present invention is not limited to the above embodiment described with reference to the drawings, and a variety of configurations are conceivable within the technical scope of the invention.

For example, in the embodiment described above, the bag body 20 is formed so as to expand from the seatback main body 4; however, the embodiment is not limited thereto. For example, the main bag 21 may be formed so as to expand from the headrest 5.

Further, in the embodiment described above, a pair of the side bags 29 is provided so as to expand to both sides in the right-to-left direction that support the trunk of the occupant; however, the embodiment is not limited thereto. Only one side bag may be provided so as to expand to one side (for example, a side close to the side surface of the vehicle room when seen from the occupant) in the width direction with respect to the trunk of the occupant. Further, the side bag may not be provided.

Further, in the embodiment described above, one end of the connection member 13 is connected to the seatback 3; however, the embodiment is not limited thereto. For example, the one end of the connection member 13 may be connected to the seat cushion 2. Further, the one end of the connection member 13 may not be connected to the vehicle seat 1 and may be connected to a pillar at a side part of the vehicle body or a floor panel of the vehicle body.

Further, in the embodiment described above, each of the pair of inflators 11 is provided corresponding to each of the pair of side bags 29; however, the embodiment is not limited thereto. For example, only one inflator may be provided corresponding to the side bag 29 on a side close to the side surface of the vehicle room when seen from the occupant among the pair of the side bags 29. Further, the inflator may include an inflator that corresponds to the main bag 21 in addition to the pair of inflators that corresponds to the side bags 29.

Further, in the embodiment described above, the connection member 13 is accommodated inside the seatback 3 in a state of being folded or in a state of being wound together with the bag body 20; however, the connection member 13 may be accommodated inside the seatback 3 in a state of being folded or in a state of being wound separately from the bag body 20. Further, there may be no connection member 13, and the occupant may be supported according to the shape stability when the bag body 20 is expanded.

The configuration elements in the embodiment described above can be arbitrarily replaced by known configuration elements without departing from the scope of the invention.

What is claimed is:

1. An air bag apparatus, comprising:
an inflator that generates a gas when an impact is input; and
a bag body that is supplied with the gas from the inflator and that is inflated and expanded from a seatback of a vehicle seat,
wherein the bag body comprises:
a trunk support part that is expanded to an opposite side of the seatback so as to support a trunk of an occupant who is seated on the vehicle seat; and
a pair of head support parts each of which is expanded to each of both sides in a width direction of the vehicle seat so as to support a head part of the occupant and that is connected to the trunk support part, and
an escape part that penetrates in a vertical direction between the pair of head support parts and that avoids the head part of the occupant in an expansion state is formed on the bag body.

2. The air bag apparatus according to claim 1,
wherein an upper end edge of the head support part is formed so as to protrude upward when seen from the width direction.

3. The air bag apparatus according to claim 1,
wherein a width of the head support part is narrower toward an upward direction when seen from the width direction.

4. The air bag apparatus according to claim 1,
wherein the bag body comprises a side bag that is expanded to at least one side of the width direction with respect to a trunk of the occupant, and
the side bag is expanded prior to the trunk support part.

5. The air bag apparatus according to claim 1, comprising a connection member that connects together the trunk support part that is inflated and expanded and any one of the vehicle seat and the vehicle body.
